(19) United States
(12) Patent Application Publication
(10) Pub. No.: US 2024/0044433 A1
(43) Pub. Date: Feb. 8, 2024

(54) BLIND BULKHEAD FITTING

(71) Applicant: Inno Workz, LLC, Cranberry Twp., PA (US)

(72) Inventor: Benjamin M. Holder, Cranberry Twp., PA (US)

(73) Assignee: Inno Workz, LLC, Cranberry Twp., PA (US)

(21) Appl. No.: 17/881,890

(22) Filed: Aug. 5, 2022

(51) Int. Cl. F16L 41/14

(52) U.S. Cl. CPC F16L 41/14

(57) ABSTRACT

A blind bulkhead fitting is configured for installation into a tank or vessel from an exterior side of the tank. The blind bulkhead fitting permits installation when the interior of the tank is not accessible. In one embodiment, the blind bulkhead fitting includes an inner fitting, an inner nut, and an outer fitting. Traditional plumbing fixtures may be attached to the outer fitting. Threads on the components of the fitting are designed to cause a tightening of the fitting when a fixture is attached to the outer fitting.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present disclosure generally relates to a bulkhead fitting. More specifically, the disclosure relates to a fitting that can be installed on a tank or vessel when access to the interior of the tank or vessel is not available.

Bulkhead fittings are standard equipment in many industrial and commercial settings. A bulkhead fitting is a watertight connection (NPT/BPT threads, quick disconnect, Sharkbite® fitting, etc.) that is fitted to any thin-walled vessel. A standard bulkhead fitting consists of a threaded male coupling inserted into a hole in the vessel, a sealing compression washer, and female nut on the inside of the vessel. The female nut is tightened on the male coupling to compress the washer and create a liquid-tight seal, even at high pressure. With the traditional fitting configured with the nut inside the tank, threading anything into the bulkhead fitting will tighten the fitting itself. Traditional bulkhead fittings are easy to install prior to the tank or vessel being placed into service, when the interior of the tank or vessel is dry and accessible. However, there are situations where it is desirable to install a bulkhead fitting on an existing vessel, which may be filled with a liquid. In addition, the inside of the vessel may be difficult or impossible to access, creating a ‘blind’ situation where the internal nut can not be installed.

To address the problem of installing ‘blind’ fittings, others have used weld-on fittings, weldless tank bushings, RV bulkhead tank fittings, and similar fittings. The weld-on fitting is a steel plumbing fitting that is welded to the outside of the vessel. This creates an excellent pressure-rated seal, but requires that the vessel be made of steel and the fitting is difficult to install and remove. A weldless tank bushing does not require welding equipment and is removable. The downside to this type of bushing is that it requires an oversized hole for installation, the gap of which is covered by a large washer. Additionally, during install and use, there is no way to keep the body of the bushing from rotating in the hole, meaning it is impossible to fully tighten either the outer nut or the plumbing line you are attempting to attach. As a result, this fitting is not usable for installation below the liquid surface level or in a pressurized situation. An RV bulkhead fitting uses a rubber or PVC grommet and threaded nut arrangement for easy installation but does not have a mechanical flange to prevent dislodgement from the tank. Thus, RV fittings are not designed for pressurized vessels and can suffer from failure if the grommet deteriorates. Therefore, it would be advantageous to develop a fitting that makes installation easier and permits retrofitting in pressurized tanks and vessels.

### BRIEF SUMMARY

According to embodiments of the present disclosure is a blind bulkhead fitting that is adapted to permit one-sided installation (i.e. exterior access only) and provides a mechanical, non-friction hold on the tank. In one example embodiment, the bulkhead fitting comprises an inner fitting, an inner nut, and an outer fitting, which may include an o-ring seal. The inner fitting is pressed through a hole in the tank from the external side of the tank and secured with the inner nut. The outer nut threads onto the inner fitting, completing the water-tight connection. The outer nut may include a standard connection, such as NPT threads.

### BRIEF DESCRIPTION OF THE SEVERAL VIEWS OF THE DRAWINGS

FIG. 1 shows the components of the bulkhead fitting, according to one embodiment.

FIGS. 2A-2B show detailed views of the inner fitting.

FIG. 3 is a detailed view of the inner nut.

FIG. 4 is a detailed view of the outer fitting.

FIG. 5A shows a cut-away view of the bulkhead fitting installed in a tank or vessel.

FIG. 5B is an external view of the fitting installed in a tank or vessel.

### DETAILED DESCRIPTION

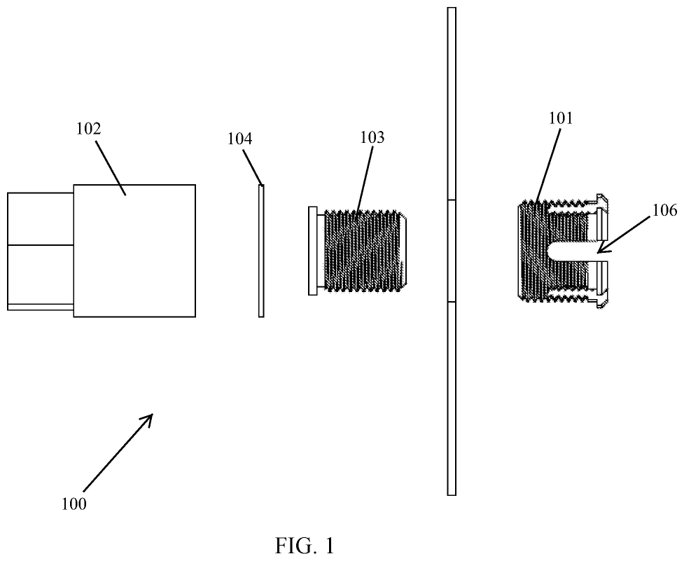

According to embodiments of the disclosure is a blind bulkhead fitting 100 comprising an inner fitting 101, an outer fitting 102, and an inner nut 103. The fitting may also include an o-ring 104 and a curved washer. As shown in FIG. 1, the inner fitting 101 includes external (right hand) threads that are adapted to engage internal threads of the outer fitting 102. The inner fitting 101 also includes internal (left hand) threads that are adapted to engage the inner nut 103. The inner fitting 101 further comprises a flange 110 or raised edge that is adapted to engage the inner wall of a tank or vessel. Relief cuts 106 on the inner fitting 101 permit the inner fitting to be compressed for installation through a hole of similar diameter to the external threads of the fitting 101. Alternatively, the inner fitting 101 may be constructed of a flexible material that permits compression without the use of relief cuts 106. The fitting 100 may be constructed of steel, stainless steel, brass, copper, PVC, nylon, other polymers, and other materials suitable for use in plumbing fixtures.

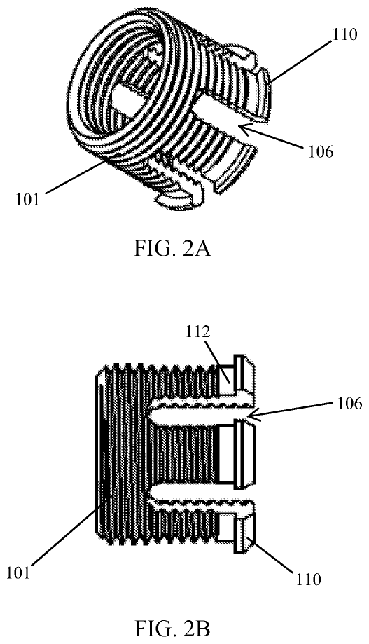

As shown in FIG. 1, the flange 110 of the inner fitting 101 is a larger diameter than the installation hole, meaning the inner flange 110 will not dislodge through the hole during use unless compressed. FIGS. 2A-2B provide a detailed view of the inner fitting 101. As shown in FIG. 2A, the inner fitting 101 includes both internal and external threads. FIG. 2B provides a detailed view of the flange 110, which has a larger diameter than the external threads and includes a chamfer on the leading edge of the flange 110 to aid installation. The size of the flange 110 can vary depending on the intended application (i.e pressure requirements, material properties, etc.), the tank wall thickness, and other factors. The limiting factor to the size of the flange 110 is that it should be able to pass through the installation hole when compressed during installation. In the example embodiment shown in FIG. 2B, the portion of the external surface adjacent to the flange 110 includes a flat section 112 that engages the hole in the tank.

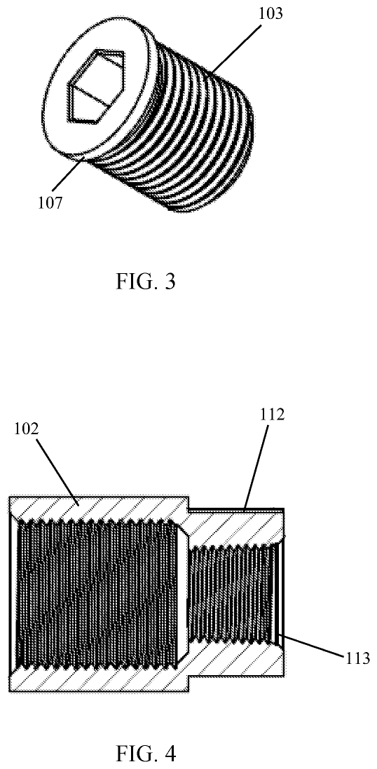

Once the inner fitting 101 is pressed into the installation hole of the tank, the inner nut 103 threads into the inner fitting 101 to prevent compression of the inner fitting 101. The inner nut 103 may include an internal hex slot to allow tightening with a hex wrench. Similar tightening methods can also be used in other embodiments. FIG. 3 shows a detailed view of the hex slot, which passes through the length of the nut 103 and permits fluid flow from one side of the tank to the other. As shown in FIG. 3, the inner nut 103 may include a depth stop 107 to prevent over-tightening.

While FIG. 1 depicts the bulkhead fitting 100 used with a thin-walled tank, the fitting 100 may be adapted for use in thicker walled tanks, vessels, and other containers. For example, the fitting 100 could be adapted by increasing the length of the inner fitting 101 for installation through the hull of a boat, which may have a greater thickness compared to wall thickness of a tank. Similarly, the fitting 100 may be used in applications involving liquids, air, and other materials.

The outer fitting 102 comprises a sealing surface for engaging the outside of the tank or vessel. Internal threads engage the external threads of the inner fitting 101. The outer fitting may also include internal NPT threads or other connection mechanisms 113 for a pipe, tubing, or a similar supply/discharge line as shown in FIG. 4. A portion of the external surface of the outer fitting 102 may include flats for a wrench. When installed, the sealing surface of the outer fitting 102 is pressed against the outer surface of the tank or vessel. An optional o-ring 104 may be placed between the sealing surface of the outer fitting 102 and the tank to act as a compression sealing surface. In addition, an optional curved washer can be used between the sealing surface of the outer fitting 102 and the tank and is useful when the tank has a small diameter, resulting in a curved surface at the interface with the fitting 100. The curved washer can have one side with a radius matching the radius of the tank.

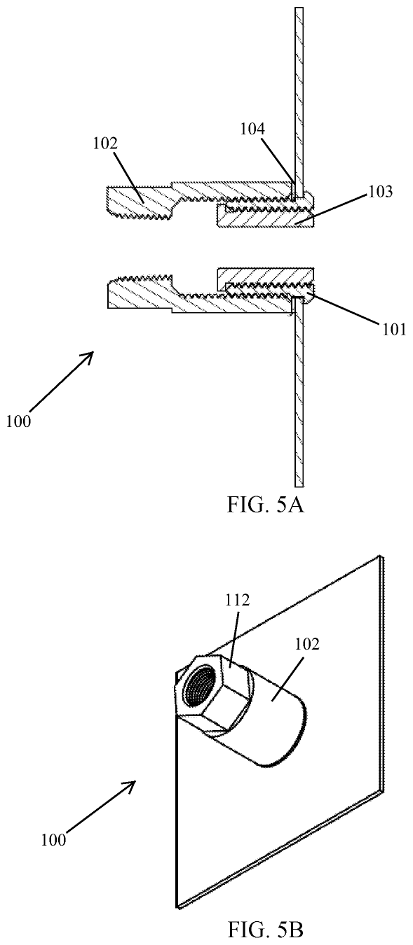

To install the blind bulkhead fitting 100, first the inner fitting 101 is inserted into a hole in the tank. In one example embodiment, the inner fitting 101 is compressed prior to installation. In another example embodiment, the flange 110 includes a slight taper on the leading edge which will force the inner fitting 101 to compress as it is driven into the hole. Next, the inner nut 103 is threaded into the inner fitting 101, locking the flange 110 against the interior of the tank wall. Next, the optional o-ring 104 and/or curved washer are installed before threading the outer fitting 102 onto the inner fitting 101. Because of the orientation of the threads, tightening a supply line onto the outer fitting 102 will also tighten the outer fitting 102 onto the inner fitting 101. FIGS. 5A-5B show the components of the fitting 100 installed on a thin-walled tank, with FIG. 5A depicting a cut-away view of the installed fitting 100.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A blind bulkhead fitting for installation on a tank comprising:
an inner fitting adapted to be installed through a hole in the tank, wherein the inner fitting includes a flange adapted to engage an inner wall of the tank;
an inner nut adapted to attach to an interior surface of the inner fitting; and
an outer fitting adapted to attach to an exterior surface of the inner fitting.

2. The blind bulkhead fitting of claim 1, further comprising:
an o-ring disposed between the tank and the outer fitting.

3. The blind bulkhead fitting of claim 1, wherein the inner fitting further comprises:
a relief cut disposed along a longitudinal axis of the inner fitting from the flange at a first end towards a second end.

4. The blind bulkhead fitting of claim 1, wherein the inner fitting further comprises:
a right hand thread disposed on an external surface of the inner fitting, wherein the right hand thread is adapted to engage a corresponding thread disposed on an inner surface of the outer fitting; and
a left hand thread disposed on an internal surface of the inner fitting, wherein the left hand thread is adapted to engage a corresponding thread disposed on an external surface of the inner nut.

5. The blind bulkhead fitting of claim 1, wherein the inner fitting further comprises a flat portion adjacent to the flange to engage an installation hole in the tank.

6. The blind bulkhead fitting of claim 1, wherein the flange includes a chamfer on a leading edge.

7. The blind bulkhead fitting of claim 1, further comprising:
a curved washer disposed between the outer fitting and the tank.

8. The blind bulkhead fitting of claim 1, wherein the outer fitting further comprises:
wrench flats disposed on an external surface of the outer fitting.

9. The blind bulkhead fitting of claim 1, wherein the outer fitting further comprises:
NPT threads.

10. The blind bulkhead fitting of claim 1, wherein the inner nut further comprises:
a depth stop comprising a raised edge disposed on a distal end of the inner nut.
